(19) United States
(12) Patent Application Publication
(10) Pub. No.: US 2014/0267640 A1
(43) Pub. Date: Sep. 18, 2014

(54) Off-Axis Guider Assembly and Methods of Assembly and Use

(71) Applicant: Samuel W. Barziza, Conroe, TX (US)

(72) Inventor: Samuel W. Barziza, Conroe, TX (US)

(21) Appl. No.: 13/797,162

(22) Filed: Mar. 12, 2013

(51) Int. Cl. H04N 5/225; G02B 23/12

(52) U.S. Cl. CPC H04N 5/2252; G02B 23/12
USPC 348/61

(57) ABSTRACT

An off-axis guide assembly provides a worm-gear or other gearing arrangement, permitting the tracking of a rotating image of an auto-guiding camera permitting a CCD camera to obtain and retain a fixed focus image of a celestial object over a period of time necessary to make a clear and focused image of the object.

### FIELD OF INVENTION

This invention relates to a telescope tracking apparatus; more specifically, to an off the main optical axis tracking apparatus for attaching a CCD unit regulating movement of the telescope while a second CCD unit captures a digital image of the astronomical target desired.

### BACKGROUND ART

In the science and hobby of astronomy, collecting data, and more precisely images, is a routine and common occurrence. Many methods and techniques are employed to achieve this. The telescope must precisely track the object being imaged or photographed, to obtain a good image with no blurs or steaks. The telescope must track an object across the night sky to keep pace with the Earth's rotation. One method used for precisely tracking an object across the night sky is to use an auxiliary camera devoted to precisely keeping the bright isophotes of a star centered on a CCD (charge coupled device) chip, or on any location on the CCD chip. The auxiliary camera must make minute changes to the telescope's position correcting for drift, motor mount tracking errors, etc. What may seem like a trivial, job, locating a “guide star” to be used for tracking purposes, which must be in close proximity to the object being imaged, is not at all trivial. In fact, more time can be spent looking for suitable guide stars than actually imaging.

There are a few methods for precisely tracking a guide star. One method is to use a smaller telescope affixed to the top of the main telescope. In this way, the user has two telescopes, one for imaging, and one for guiding. Another method utilizes a CCD camera having two CCD chips, one large CCD chip for imaging and an adjacent smaller CCD chip for guiding the telescope on a star. Both methods have pros and cons.

Yet another method useful for finding guiding stars for tracking purposes, is the use of a device called an off-axis guider. Off axis guiders are well known in the field. All off-axis guiders employ a prism or a pick off mirror to divert a small portion of the light from a telescope to an eyepiece or camera of some type.

Off-axis guiders offer a few important advantages over a dedicated guide scope, or a dual CCD chip camera. Off-axis guiders are more affordable than either a guide scope or dual chip camera. An off-axis guider can be placed almost any where in the optical train, more importantly in front of colored filters, which a dual chip camera cannot do. This alone has serious drawbacks for a dual chip CCD camera. An off axis guider will not suffer from differential flexure which sometimes can occur when using a separate guide scope. Moreover, an off-axis guider can obtain more precise tracking of the desired astronomical object than a separate guide scope.

The proposed off-axis guider described herein, is a unique and novel device, having several critical, essential features designed to make locating guide stars easier.

Currently, there is no off axis guider that has a controlled rotating prism, and or that can move in or out of the optical axis, made for small amateur telescopes.

The off-axis guider of the present disclosed embodiment is a newly designed off-axis guider. This apparatus features a right angle prism that can rotate about the telescope axis; and, travel in or out of the optical axis. Also the off-axis guider of this application has a built-in focuser for the auto-guiding CCD camera. The off-axis guider disclosed herein may be constructed from aluminum or any other metal or material as desired.

Rotation around the optical axis is achieved by the use a knob, attached to a screw. The screw acts upon a matching gear. The gear is attached to the body that holds the guiding camera port. The guiding port can be raised or lowered, in or out of the optical axis by the use of a threaded ring that engages a thread. The thread on this guide port is fixed and cannot rotate, and since the ring is turned around the fixed non-rotating guiding port, it moves the guiding port up or down raising or lowering the prism in or out of the optical axis allowing more photons to reach the main CCD camera, thereby improving the images obtained.

It is this same manner that is used to bring the auto-guiding camera into focus. Locking thumbscrews are used to secure all moving parts when a guide star is found and focused.

The off-axis guider of this application can be fabricated with threads on the front and rear of the unit, or have a smooth inside diameter with perpendicular set screws, to allow the attachment of the off-axis guider assembly to a telescope or camera.

Any worm or worm gear or other gearing mechanism can be used. Placement of gear or worm on either the outside or housed inside of the unit without departing from the spirit of the invention. Movement of the prism in or out of the optical axis can be either a screw type arrangement or a sliding mechanism. Focusing can also be a screw type or a sliding mechanism. All of these alternatives are well known in the telescope fabrication art.

Motors can be attached to any motion of the off-axis guider. Bearings can be employed anywhere as desired, although are not required for smooth operation of the moving elements of this device.

The off-axis guider assembly can be made to offer 1, 2 or 3 axes of controlled motion. The prism can rotate around the optical axis. The prism can move in or out of the optical axis. The auto-guiding camera can be brought into focus.

### BRIEF DESCRIPTION OF DRAWINGS

FIG. 1 is a perspective side view of the off-axis guider assembly on a telescope.

FIG. 2 is a planar side view of the off-axis guider assembly mounted on a telescope.

FIG. 3 is a closer view of the off-axis guider assembly of FIG. 2.

FIG. 4, is a disassembled view of the off-axis guider assembly.

FIG. 5 is a close-up of disassembled view FIG. 4.

FIG. 6 is a disassembled view of the off-axis guider assembly.

FIG. 7 is a detailed perspective side view of the worm gear assembly.

FIG. 8 is an end view of the off-axis guider assembly.

FIG. 9 is a cross-sectional view of the off-axis guider assembly through the midline of FIG. 8

FIG. 10 is a disassembled view of the off-axis guider assembly showing all elements.

FIG. 11 is a diagram displaying approximate range of travel or rotation about the optical axis of the off-axis guider assembly.

FIG. 12 is a perspective view of the exterior of the off-axis guider assembly with motor attached.

FIG. 13 is the off-axis guider assembly with the front cover removed.

FIG. 14 is the assembled off-axis guider assembly.

FIG. 15 is an exploded perspective view of FIG. 14.

This is an application of an off-axis guider assembly and methods and use of the assembly on a telescope.

The present invention relates to a new and non-obvious assembly that can be used to provide an off-axis guide for astronomical viewing which tracks guide celestial bodies, such as guide stars, automatically and which can be skewed automatically by computer controlled devices. The axis of viewing can be changed dynamically to keep the tracking of the astronomical scene under investigation to allow time-extended astronomical photography to be accomplished easily and economically.

### SUMMARY OF INVENTION

An off-axis guider assembly is made from an adapter connected to a telescopic instrument; an off-axis guider body attached to the adapter attached to the telescopic instrument; a connector interposed between a photographic assembly comprised of an filter wheel and a camera; and, a worm-gear mechanism for moving the off-axis guider body around the circumferential axis of the optical axis connected to an auto-guiding guide camera.

The off-axis guider assembly can also provide an off-axis guider comprised of a secondary camera useable for guiding a telescope. The off-axis guider assembly can also provide a right-angle prism while permitting the passage of viewing to be passed to the primary focus of the camera having a principal focus of the telescope.

An off-axis guider assembly provides a fixed body; a rotating piece cooperating with the fixed body; a moveable prism attached to the rotating piece for moving a prism into and out of an optical axis of a telescopic instrument; and, a worm gear for moving the rotating piece around the axis of the optical axis of the telescopic instrument.

The off-axis guider assembly can further comprise a focus ring for moving a guider assembly auto guider around the perpendicular axis of the off-axis guide assembly and a worm gear controlled by a computer-assisted stepper motor to track the movement of a guide celestial body.

A method of installing an off-axis guider assembly on a telescopic instrument comprising the steps of inserting an adapter on the telescope; attaching the off-axis guider assembly to the adapter providing an off-axis auto-guiding camera to the assembly; attaching an adapter to a filter wheel of an CCD camera; and, attaching the CCD camera to the adapter.

A method of using an off-axis guider assembly on a telescopic instrument for photographically capturing the image of a celestial object can also comprise the steps of determining an appropriate guide point; focusing an auto-guiding camera on the appropriate guide point; activating the auto-tracking element of a CCD camera to follow the appropriate guide point; and, initiating the tracking and capture of the desired image of the celestial object with the CCD camera using the off-axis guider to skew the camera to maintain the focus of the camera.

### DETAILED DESCRIPTION OF EMBODIMENTS OF INVENTION

FIG. 1 is a perspective view of the off-axis guider assembly 3 attached to a telescope 1 with an auto-guiding camera 6 and a filter wheel 4 and the main camera 5 also showing the telescope receptacle 2 for affixing equipment. FIG. 1 discloses a complete telescope, off-axis guider assembly and CCD camera disclosing the use of the present invention for maintaining a guide on a desired celestial image on the focal plane of the CCD camera. Since the guide object, typically a stellar image within the viewing field of the desired primary celestial object under investigation, takes only a small portion of the viewing image and moves throughout the time required to obtain a clear visual image of the celestial image during a photograph exploration, the image must be maintained centrally located within the focal image of the tracking camera. Since the image can move in more than one direction, the tracking camera must be able to move in both the X and Y-axis as the guide object moves across the visual field. This requires the CCD to be moved in both axes as the earth moves about its solar axis.

By establishing the auto-guiding camera on the perpendicular axis and intercepting a portion of the optical viewing made by the telescope, as the auto-guide camera moves it tracks the fixed position while allowing movement of the CCD camera to move the CCD in fixed relationship to the celestial object under study, permitting the clearest view and capture of the object on the CCD plate. In manual installations, viewing the guide and maintaining the image in the cross hairs of the guide camera on the object do this. This can also be done automatically sending a skewing coordinates to the CCD camera focusing arrangement.

FIG. 2 is a planar side view of the off-axis guider assembly 3 attached to a telescope 1 with an auto-guiding camera 6 and a filter wheel 4 and the main camera 5 with the telescope receptacle 2 for affixing equipment. This more detailed view of the off-axis guider assembly attached to an adapted attached to the telescope shows the relative position of each element. On a perpendicular axis of the guide assembly, the auto-guiding camera connects to the assembly using an adapter that allows moveable engagement of the assembly to the camera. Along the longitudinal axis 19 of the assembly 3 (as shown in FIG. 9) is an adapter that attaches to a filter assembly 4, which is, in turn, attached to a CCD camera 5. These adapter connections 8, 9, 10 can be threaded or compression fittings in a manner well known in the industry and based upon the personal preferences of the owner of the CCD camera and telescope.

As shown in FIG. 3, the assembly 3 is attached to a filter assembly which is intermediate the CCD camera permitting the assembly to be affixed to the exterior face of the filter.

As shown in FIGS. 4, 5 and 6 the off-axis guider assembly 3 is attached to a telescope 1, by means of an adapter 7, inserted into telescope receptacle 2 with an auto-guiding camera 6 attached by an adapter 11, and a filter wheel 4 and the main camera 5. Adapters 8, 9, and 10 attach filter wheel 4 to the off-axis guider assembly 3. The principal optical axis of the CCD camera is not obstructed by smaller and less obtrusive prism of the tracking camera of the guide assembly. Since the worm-gear of the guide assembly 3, operated in this view by knob 12, can be engaged to move around the periphery of the principal optical axis of the CCD camera, the guiding can be accomplished without diminishing the “viewing” of the CCD camera.

FIG. 7 shows a closer detail perspective view of the interior of the guide assembly. A worm gear 28, as shown in FIG. 10, can be engaged to move the moveable ring of the guide assembly 3 about the central axis of the telescope. An adjustable collar contained on the perpendicular axis 18 to the guide assembly 3 can be used to establish and maintain the tracking camera in focus on the guide celestial object. As may be obvious from this view, the prism view 16 provided the tracking camera only peripherally intrudes on the optical axis of the CCD camera. The focus guide ring allows movement of the focal plane up or down toward the prism face to focus the guide camera on the guide image selected by the user to track the object for the CCD camera. A worm gear connected to knob 12 and adapted for movement of the rotating piece can be adapted for either manual or motorized movement, or both to maintain the guide object in the cross hairs of the guide camera.

FIGS. 8 and 9, a partial front and cross-sectional view along the F axis of FIG. 8 of the guide assembly shows the optical path 17 of the telescope captured by the prism 16 and sent to the auto-guider camera. This can be modified to allow movement automatically to the worm gear also show in this view, which can be both manually with knob 12 or automatically adjusted with motors 40 and guide camera motor 48 (as shown in FIG. 15) to keep the guide object within the cross-hairs of the auto-guider.

Further, FIG. 9 is a close-up view of the guide assembly 3 showing a fixed body affixed to the optical axis of the telescope, supporting the rotating piece that supports the perpendicular axis 18 of the guide assembly 3. FIG. 9 also depicts a cross-sectional view of the off-axis guide showing the light path 19 through the body of the device, including the ability of the prism 16 to intercept a portion of the incoming photo stream 17 to guide the tracking device.

FIG. 10 is an exploded view of an embodiment of the off-axis guide 3 showing the relative arrangement of all portions of the assembly. The rotating prism port 24 fits on the outside of fixed body 23. Attached to prism port 24 is a worm gear 27, which is bolted to prism port 24 with machines screws 33. Worm screw mount 25 is attached to fixed body 23 with machine screws 33. Knob 31 is attached to long set screw 30 which is attached to worm screw 28. The worm screw 28 is held in place by a smallholder 29. Locking thumbscrews 32 lock prism port body 24 in position. Stop 26 holds item 24 on fixed body 23. Stop 26 is attached with machines screws 33. On rotating body 24, a small protruding boss item 24′ extends from the body. Opening 24″ in boss 24′ is made to accept the shape or profile of prism post 21. Post 21 is threaded and provides a flat surface item 21″ is made to slide in the opening of item 24″. Threaded ring 13 is slipped onto boss 24′. Holder 20 bolts onto threaded ring 13 with machine screws 33 thru holes 20′ on holder 20. Threaded ring 13 engages threads on prism post 21. Prism post 21 has a similar thread arrangement as boss 24′. Focusing ring 14 slips onto prism post 21 and is bolted onto post 21 with machine screws 33 through small plate 22. Plate 22 has holes item 22′ for the machine screws. Thumbscrews 34 are used on focusing rings 14, adapter 15 and threaded ring 13. Auto Guiding adapter 15 also has a threaded outside surface with a milled flat 15′. This adapter 15 slides into opening 21″. Prism 16 is bonded to prism post 21.

FIG. 11 is a schematic view of the range of motion 36 of the prism mount within the off-axis guider allowing the guide to follow the transverse movement of the guide previously imaged in the tracking guide.

FIGS. 12 and 13 are descriptions of an alternative embodiment of the off-axis guide and showing the cover 44 removed from the guide disclosing the gearing mechanism 44 of the motorized worm gear, moved by motor 40. Further, FIGS. 12 and 13 show an alternative form of the existing invention moving the worm gear 44 in response to the signal received by the tracking camera 6, as previously shown in FIGS. 1-4.

FIGS. 14 and 15 show the assembly of the embodiment in FIGS. 12 and 13 with the automatic motorized prism adjustment 48 mounted on the off-axis guide assembly 46 The off-axis guide assembly 47 moves the tracking CCD camera (6 in FIGS. 1-3) to keep the guide star in focus during the image capture by the main CCD camera 5 (FIGS. 1-3) and can be programmed to move the prism completely out of the optical path of the telescope.

The foregoing disclosure and description of the invention are illustrative and explanatory thereof, and various changes in size, shape and material as well as in the details of the illustrated construction may be made without departing from the spirit of the invention.

What is claimed is:

1. An off-axis guider assembly comprising:
an adapter connected to a telescopic instrument;
an off-axis guider body attached to the adapter attached to the telescopic instrument;
a connector interposed between a photographic assembly comprised of an filter wheel and a camera; and,
a worm gear or gearing mechanism for moving the off-axis guider body around the circumferential axis of the optical axis connected to an auto-guiding guide camera.

2. The off-axis guider assembly of claim 1 wherein the off-axis guider is comprised of a secondary camera useable for guiding a telescope.

3. The off-axis guider assembly of claim 1 wherein the off-axis guider provides a right-angle prism while permitting the passage of viewing to be passed to the primary focus of the camera having a principal focus of the telescope.

4. An off-axis guider assembly comprising:
a fixed body;
a rotating piece cooperating with the fixed body;
a moveable prism attached to the rotating piece for moving a prism into and out of an optical axis of a telescopic instrument; and,
a worm gear or other gear for moving the rotating piece around the axis of the optical axis of the telescopic instrument.

5. The off-axis guider assembly of claim 4 further comprising a focus ring or a mechanical device for focusing auto guider camera, and for moving a guider assembly auto guider around the perpendicular axis of the off-axis guide assembly.

6. The off-axis guider assembly of claim 4 wherein the worm gear or gear is controlled by a computer assisted stepper motor to locate a suitable guide star, for tracking the movement of a guide celestial body.

7. A method of installing an off-axis guider assembly on a telescopic instrument comprising the steps of:
inserting an adapter on the telescope;
attaching the off-axis guider assembly to the adapter providing an off-axis auto-guiding camera to the assembly;
attaching an adapter to a filter wheel of an CCD camera; and,
attaching the CCD camera to the adapter.

8. A method of using an off-axis guider assembly on a telescopic instrument for photographically capturing the image of a celestial object comprising the steps of:
determining an appropriate guide point;
focusing an auto-guiding camera on the appropriate guide point;
activating the auto-tracking element of a CCD camera to follow the appropriate guide point; and,
initiating the tracking and capture of the desired image of the celestial object with the CCD camera using the off-axis guider to skew the camera to maintain the focus of the camera.
